(19) United States
(12) Patent Application Publication
(10) Pub. No.: US 2026/0221334 A1
(43) Pub. Date: Jul. 30, 2026

(54) COIL DEVICE

(71) Applicant: TDK Corporation, Tokyo (JP)

(72) Inventors: Masaaki IWAKURA, Tokyo (JP); Toshiyuki HORIKAWA, Tokyo (JP); Masayuki NAGATA, Tokyo (JP); Masato FUJITA, Tokyo (JP); Kaito TANIZAKI, Tokyo (JP)

(73) Assignee: TDK Corporation, Tokyo (JP)

(21) Appl. No.: 19/456,007

(22) Filed: Jan. 22, 2026

(30) Foreign Application Priority Data
Jan. 27, 2025 (JP) 2025-011574
Feb. 27, 2025 (JP) 2025-030181

(51) Int. Cl. H01F 27/30; H01F 27/02

(52) U.S. Cl. CPC H01F 27/306; H01F 27/022; H01F 27/025

(57) ABSTRACT

A coil device includes a wire, a bobbin including a wound portion provided with a winding portion of the wire, a core including an outer leg portion disposed outward from the winding portion, and a case accommodating at least a part of the winding portion and at least a part of the outer leg portion. The at least a part of the winding portion and the at least a part of the outer leg portion in the case are sealed with a sealing member. The wound portion of the bobbin includes a partition flange portion partitioning the winding portion into sections along a winding axis of the winding portion. The partition flange portion includes a peripheral edge in a radial direction disposed closer to the wound portion than an outer end of an outermost layer of the winding portion is.

The present application claims a priority to Japanese patent application No. 2025-011574 filed on Jan. 27, 2025, and Japanese patent application No. 2025-030181 filed on Feb. 27, 2025, which are incorporated herein by reference in their entirety.

### BACKGROUND

The present disclosure relates to a coil device, such as a transformer.

Patent Document 1 discloses a cased transformer. Having the inside of a case sealed with a resin, a transformer like the one disclosed in Patent Document 1 is expected to have higher impact resistance, higher heat-dissipation capability, or the like. However, such a transformer may malfunction as it is used repeatedly.

Patent Document 1: JP Patent Application Laid Open No. 2014-36194

### SUMMARY

The present inventors have found, through diligent and thorough research, that heat generation by a coil of a transformer described above causes an expansion of a sealing member sealing the inside of a case to exert force by the expansion on a core, causing a malfunction. According to the research by the present inventors, inclusion of low-expansion particles with a small coefficient of linear thermal expansion in the sealing member disposed inward from an outer leg portion has been able to solve such a malfunction; however, as a space between the outer leg portion and a winding portion is widened to fill the space inward from the outer leg portion with such a sealing member, the device has had to be increased in size. Accordingly, through further research, the present inventors have finally achieved a coil device according to the present disclosure.

A coil device according to one aspect of the present disclosure includes
a wire,
a bobbin including a wound portion provided with a winding portion of the wire,
a core including an outer leg portion disposed outward from the winding portion, and
a case accommodating at least a part of the winding portion and at least a part of the outer leg portion,
wherein
the at least a part of the winding portion and the at least a part of the outer leg portion in the case are sealed with a sealing member,
the wound portion of the bobbin includes a partition flange portion partitioning the winding portion into sections along a winding axis of the winding portion, and
the partition flange portion includes a peripheral edge in a radial direction disposed closer to the wound portion than an outer end of an outermost layer of the winding portion is.

### BRIEF DESCRIPTION OF THE DRAWING(S)

FIG. 1 is an overall perspective view of a coil device according to one embodiment of the present disclosure.

FIG. 2 is an exploded perspective view of the coil device shown in FIG. 1.

FIG. 3A is a perspective view of a structure of a core of the coil device shown in FIG. 1.

FIG. 3B is a perspective view of another example of the core shown in FIG. 3A.

FIG. 3C is a perspective view of still another example of the core shown in FIG. 3A.

FIG. 4A is a perspective view of structures of a bobbin and wires of the coil device shown in FIG. 1.

FIG. 4B is a side elevational view of the bobbin and the wires of the coil device shown in FIG. 4A.

FIG. 4C is a plan view of the bobbin and the wires of the coil device shown in FIG. 4A.

FIG. 5 is a cross-sectional view along a line V-V shown in FIG. 1.

FIG. 6A is a cross-sectional view along a line VIA-VIA shown in FIG. 1.

FIG. 6B is an enlarged view of a structure of a sealing member in a part VIB shown in FIG. 6A.

FIG. 7 is a cross-sectional view along a line VII-VII shown in FIG. 6A.

### DETAILED DESCRIPTION

Hereinafter, embodiments of the present disclosure are described with reference to the drawings. Illustrations in the drawings are only schematically and exemplarily provided for understanding of the present disclosure; and the illustrated appearance, dimensional ratios, or the like may not be exactly the same as those of an actual device. The present disclosure is not limited to the following embodiments.

### First Embodiment

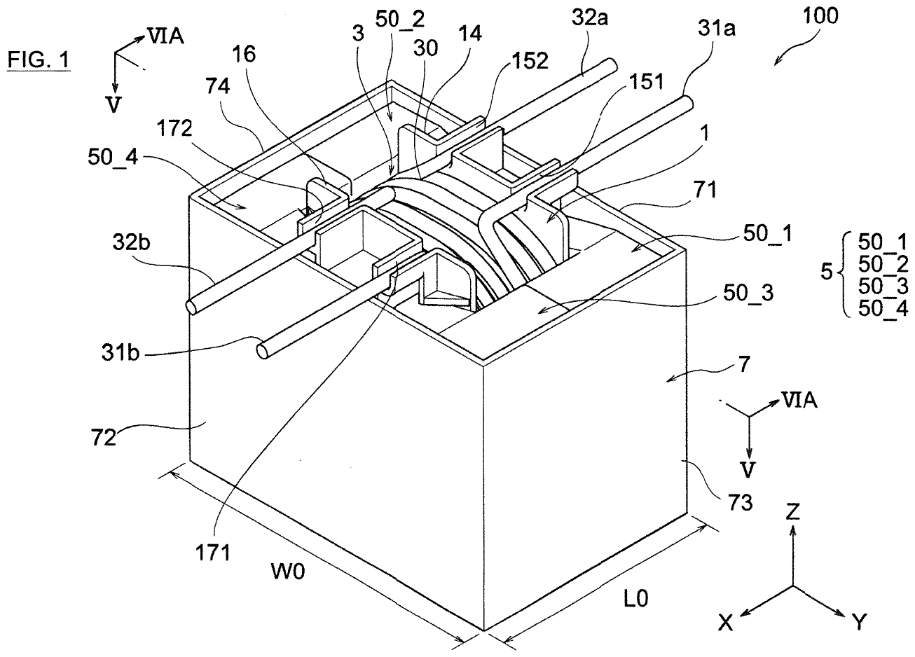

A coil device 100 according to the present embodiment shown in FIG. 1 has a function as, for example, a transformer. The coil device 100 may be included in, for example, an onboard charger for an electric vehicle (EV), a plug-in hybrid vehicle (PHV), or a commuter vehicle; a power circuit of electronic equipment for home or industrial use; or a power circuit of computer equipment.

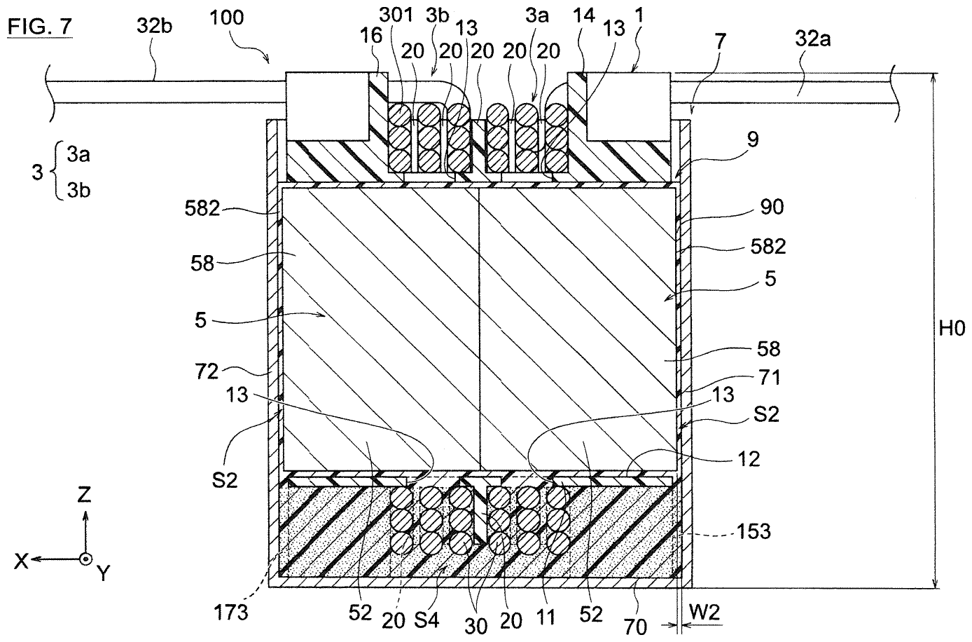

The coil device 100 may have any size. The coil device 100 may have, for example, a length L0 of 1 cm to 20 cm in the X-axis direction, a width W0 of 1 cm to 20 cm in the Y-axis direction, and a height H0 (see FIG. 7) of 1 cm to 20 cm in the Z-axis direction.

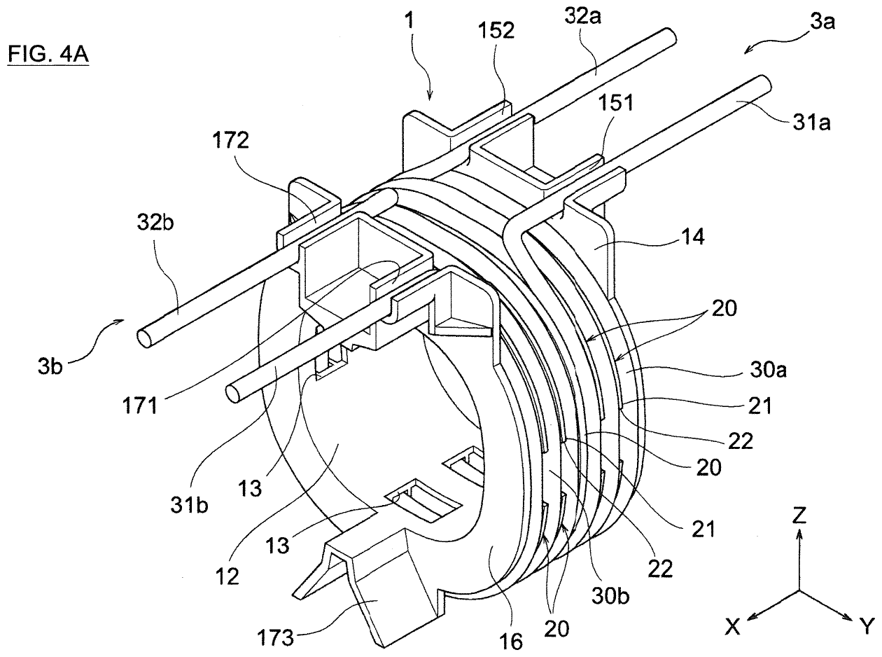

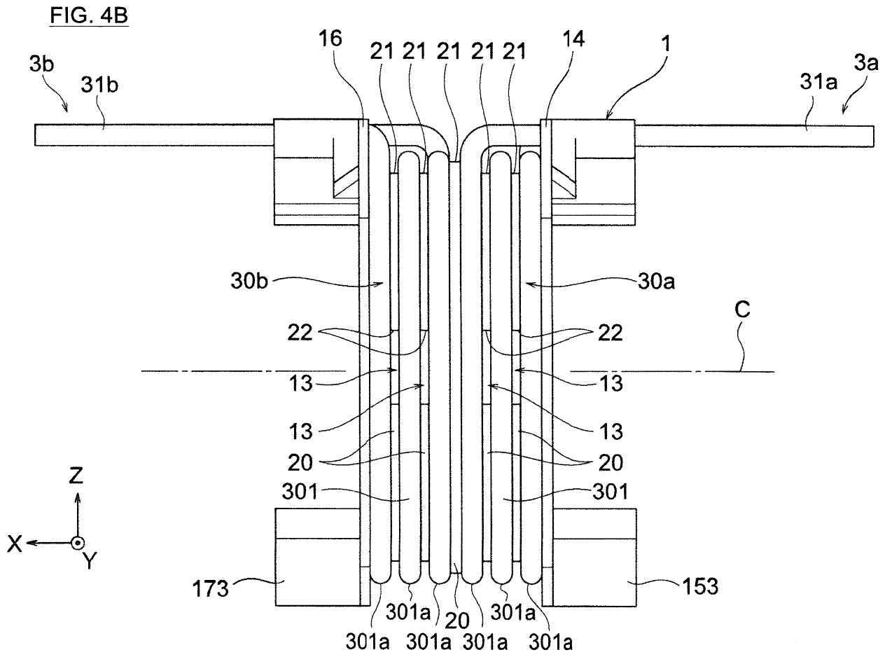

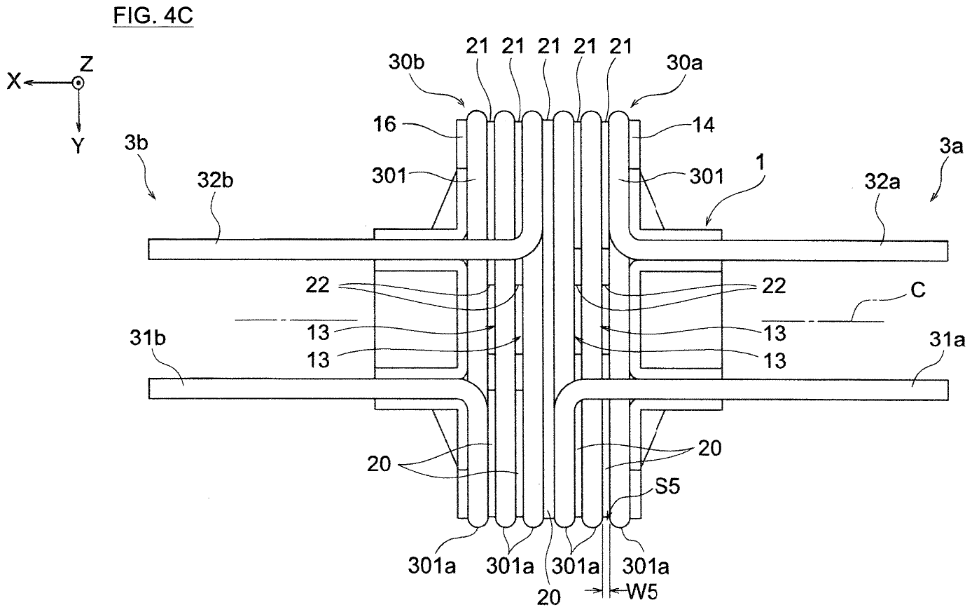

In the drawings, the X-axis extends along a winding axis C (see FIGS. 4B and 4C) of a coil; and the X-axis, the Y-axis, and the Z-axis are perpendicular to each other. In the following description, the Y-axis direction may be referred to as a width direction whereas the Z-axis direction may be referred to as a height direction. A direction toward a center of the coil device 100 may be referred to as an inward direction whereas a direction away from the center of the coil device 100 may be referred to as an outward direction. A direction or a side indicated by the tip of an arrow showing the Z-axis may be referred to as an upward direction or an upper side, based on the orientation of the drawings.

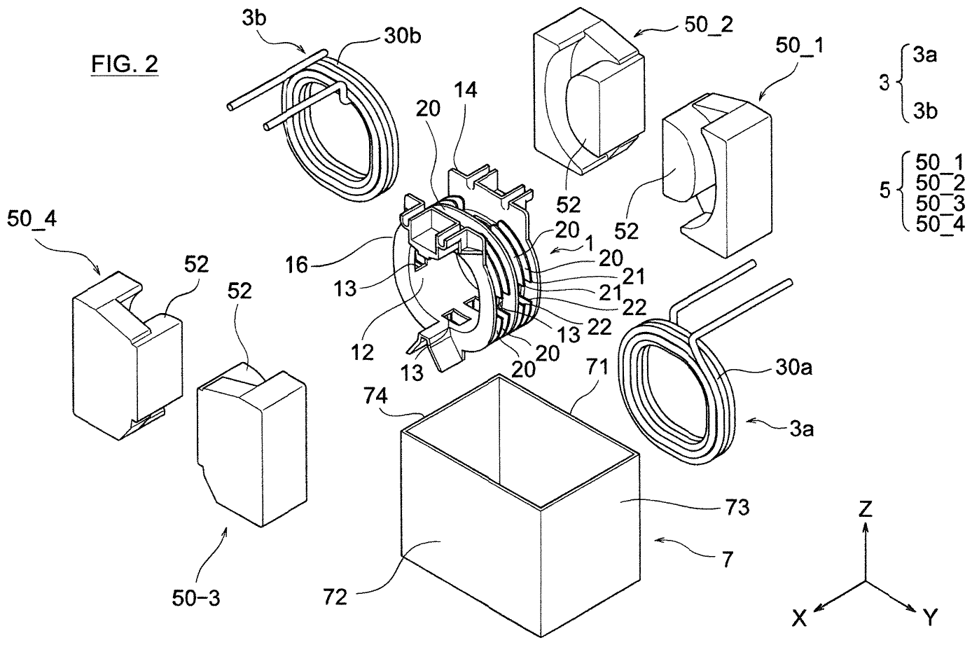

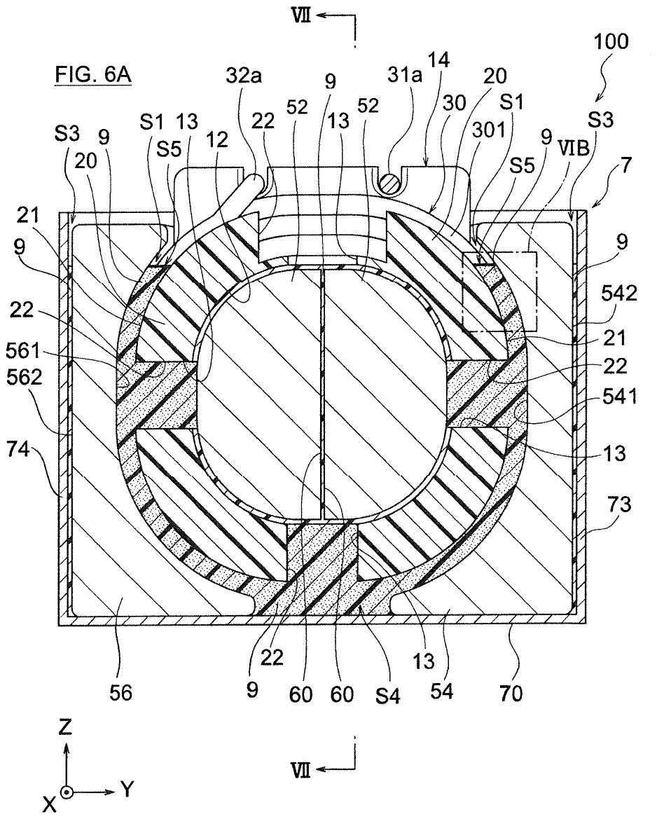

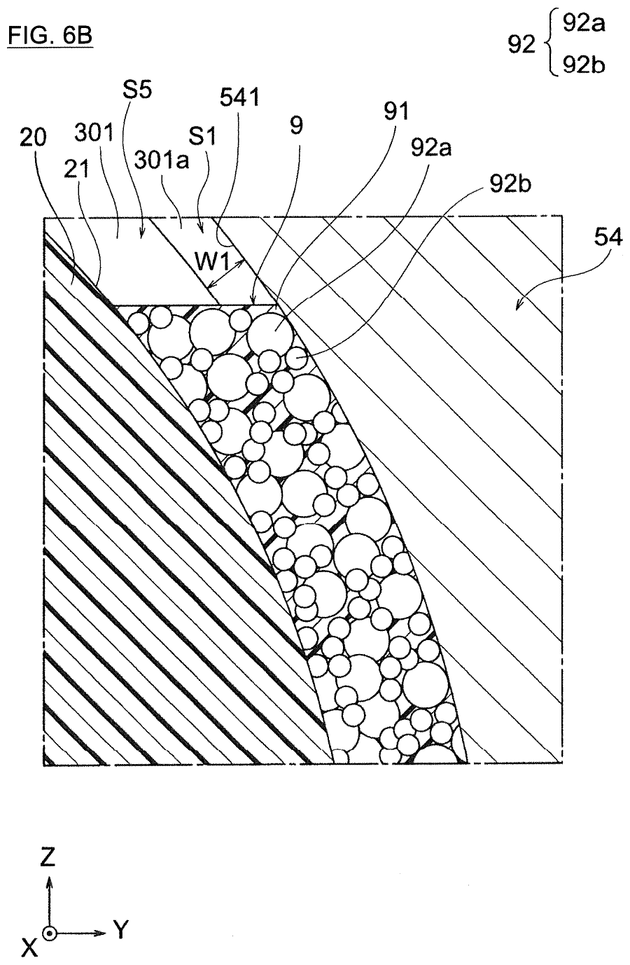

As shown in FIG. 2, the coil device 100 includes a bobbin 1, wires 3a and 3b, and a core 5, in brief. As shown in FIG. 1, they are accommodated in a case 7 and are partly sealed with a sealing member (see, for example, FIG. 6A). In the present specification, the wire 3a or the wire 3b may be referred to as a wire 3. The core 5 includes split cores 50_1, 50_2, 50_3, and 50_4 in combination. In the present specification, the split cores 50_1, 50_2, 50_3, and 50_4 may be referred to as the core 5.

The bobbin 1 is composed of an insulating member that insulates the wires 3 from the core 5. Examples of such insulation members include plastics such as PPS, PET, PBT, and LCP.

As each of the wires 3, a known conductor can be used. The wire 3 may be composed of, for example, a known insulation coated wire whose surface of a conductive wire (e.g., copper) is insulation coated with a polyimide film or the like. The wire 3 may be composed of a single wire or stranded wires. The wire 3 may have a wire diameter (diameter) of, for example, 1.0 to 3.0 mm. The wires 3 may have the same diameter but may have different diameters.

As shown in FIG. 2, the bobbin 1 includes a wound portion 11 extending along the X-axis and end flange portions 14 and 16 at both ends of the wound portion 11 in the X-axis direction, in brief. Around the wound portion 11, the wires 3a and 3b are wound. The wound portion 11 has a through hole 12 extending in the X-axis direction. The wound portion 11 has outer circumferential holes 13 communicating with the through hole 12. Into the through hole 12, middle leg portions 52 of the core 5 are inserted.

As shown in FIG. 4A, the wire 3a includes a winding portion 30a wound around the wound portion of the bobbin 1 and lead portions 31a and 32a drawn out from the winding portion 30a. The wire 3b includes a winding portion 30b wound around the wound portion of the bobbin 1 and lead portions 31b and 32b drawn out from the winding portion 30b. In the present specification, the winding portion 30a or the winding portion 30b may simply be referred to as a winding portion 30.

As shown in FIGS. 4B and 4C, the wound portion 11 includes partition flange portions 20 along the X-axis between the end flange portions 14 and 16. The partition flange portions 20 protrude in a radial direction perpendicular to the winding axis C and have a thickness with a width W5 in the X-axis direction.

As shown in FIGS. 4B and 4C, the wound portion 11 is partitioned by the partition flange portions 20 into six sections along the X-axis direction. The winding portion 30a is disposed in three sections close to the end flange portion 14. The winding portion 30b is disposed in three sections close to the end flange portion 16. As shown in FIG. 4C, outermost layers 301 of the winding portions 30 in the radial direction in adjacent sections are disposed with a space S5 having the width W5 therebetween in the X-axis direction correspondingly to the thickness of the partition flange portions.

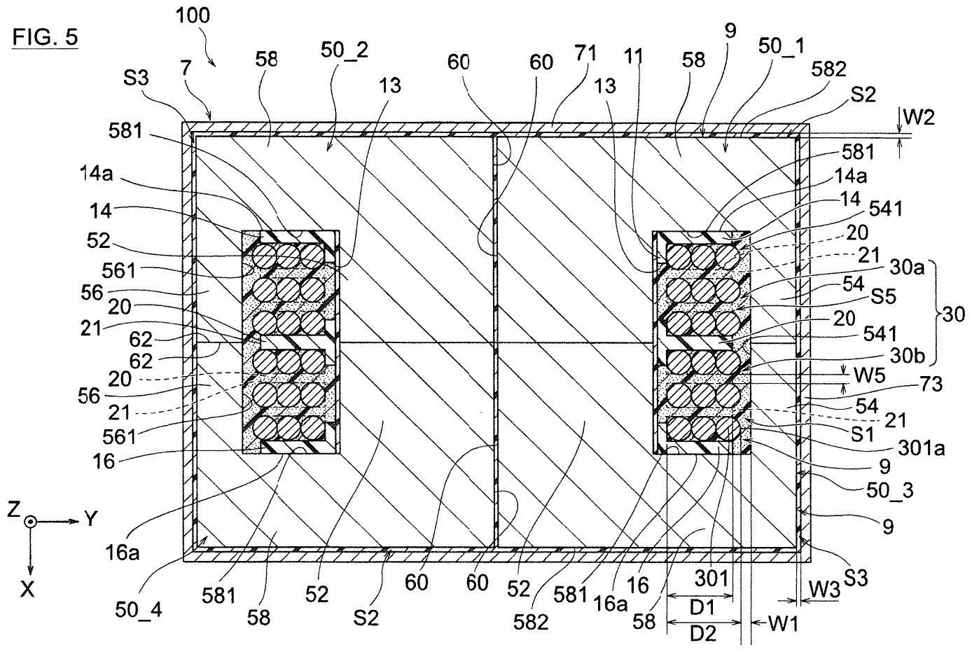

In the present embodiment, the winding portion 30 is disposed in each section so that one layer of the winding portion 30 is disposed there along the winding axis C (the X-axis direction); however, the number of layers in the X-axis direction is not limited. Multiple layers may be disposed in each section along the X-axis direction. As shown in FIGS. 5 and 7, in the present embodiment, the winding portion 30 is wound in each section so that three layers of the winding portion 30 overlap in the radial direction perpendicular to the winding axis (direction perpendicular to the X-axis); however, the number of layers in the radial direction in each section is not limited. The number of layers may be one, two, or four or more.

As shown in FIGS. 4B and 4C, peripheral edges 21 of the partition flange portions 20 in the radial direction are adjacent to the outermost layers 301 of the winding portions 30 in the radial direction. The peripheral edges 21 are disposed closer to the wound portion than outer ends 301a of the outermost layers 301 in the radial direction are. That is, as shown in FIG. 5, a distance D1 between the wound portion 11 and the peripheral edges 21 of the partition flange portions 20 is shorter than a distance D2 between the wound portion 11 and the outer ends 301a of the outermost layers 301. The distance D1 may be shorter than the distance D2 by, for example, about one-third to about two-thirds of the diameter of the wire 3, or about half the diameter of the wire 3.

The distance D1 and the distance D2 are not limited. However, in terms of preventing the winding portions 30 from being irregularly wound, the peripheral edges 21 are preferably disposed farther from the wound portion than inner ends 301b of the outermost layers 301 are.

In the present embodiment, except for the partition flange portion 20 between the winding portions 30a and 30b, the other partition flange portions 20 have notches 22. The notches 22 extend from the peripheral edges 21 of the partition flange portions 20 to the wound portion 11. The outer circumferential holes 13 of the wound portion 11 are provided at locations corresponding to the notches 22 (see FIG. 6A). Note that the partition flange portion 20 between the winding portions 30a and 30b may also have notches.

As shown in FIG. 4A, the end flange portion 14 has lead grooves 151 and 152 at the upper side in the Z-axis direction. In the lead groove 151, the lead portion 31a is disposed. In the lead groove 152, the lead portion 32a is disposed. The lead grooves 151 and 152 extend along the X-axis direction. The lead portions 31a and 32a are drawn outward along the X-axis direction.

As shown in FIG. 4A, the end flange portion 16 has lead grooves 171 and 172 at the upper side in the Z-axis direction. In the lead groove 171, the lead portion 31b is disposed. In the lead groove 172, the lead portion 32b is disposed. The lead grooves 171 and 172 extend along the X-axis direction. The lead portions 31b and 32b are drawn outward along the X-axis direction.

As shown in FIG. 4A, the end flange portion 16 includes a mounting portion 173 at a lower side in the Z-axis direction. Similarly, the end flange portion 14 includes a mounting portion 153, which is symmetric with the mounting portion 173 with respect to a YZ plane, at the lower side in the Z-axis direction (see FIG. 7). The mounting portions 153 and 173 are mounted on a bottom surface 70 of the case 7 shown in FIG. 7 to enable the bobbin 1 to be stably mounted inside the case 7.

Examples of materials of the core 5 shown in FIG. 1 include magnetic materials such as metals and ferrites but are not limited thereto. The split cores 50_1, 50_2, 50_3, and 50_4 constituting the core 5 may be composed of similar materials but are not necessarily composed of the same material.

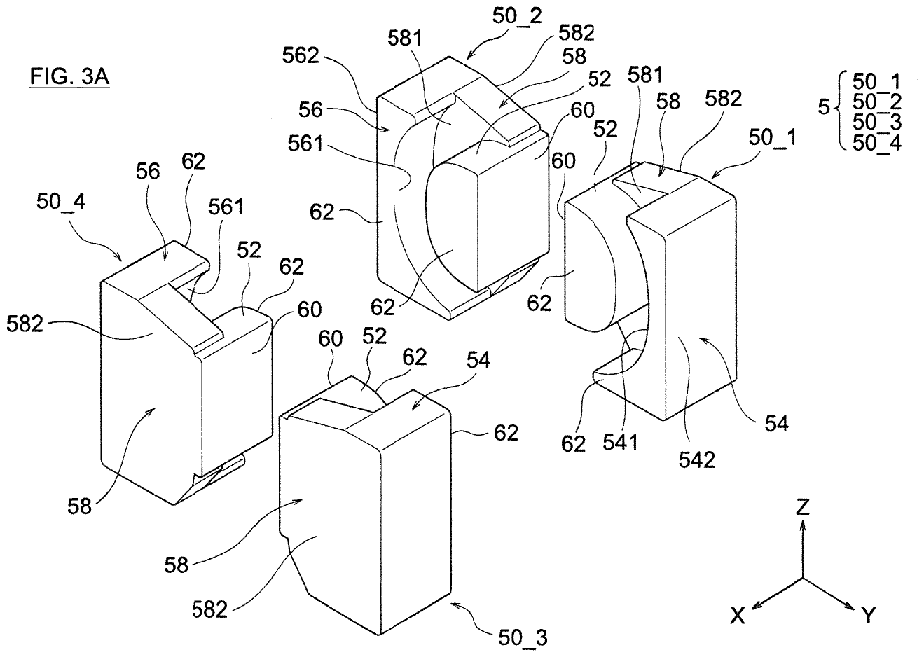

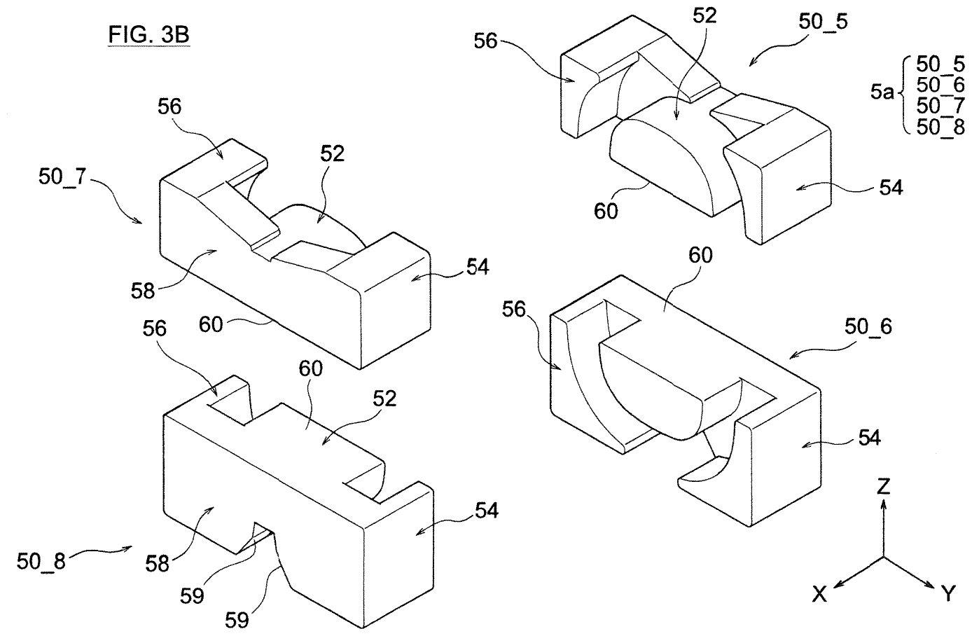

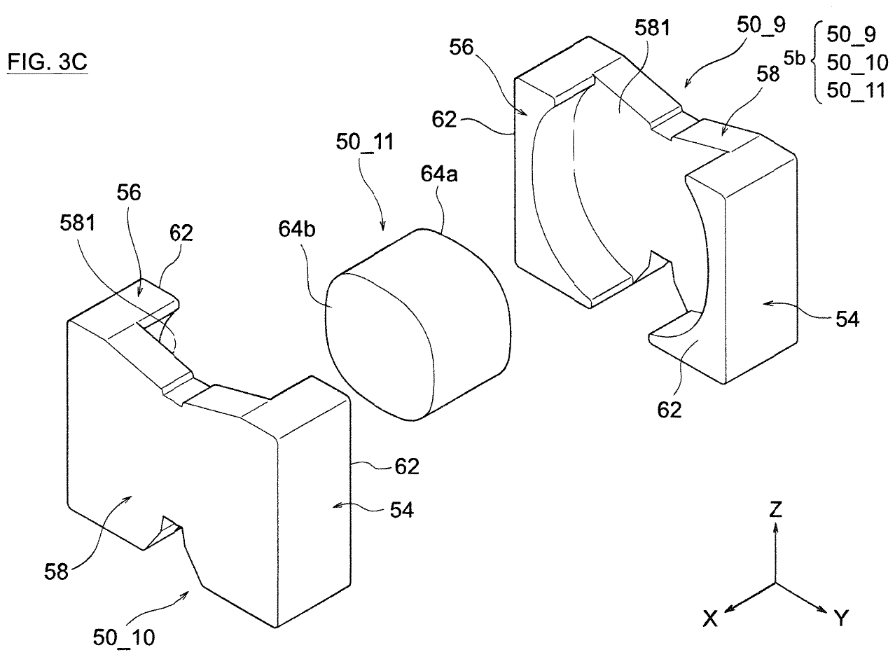

As shown in FIG. 3A, the split core 50_1 includes a base portion 58, a middle leg portion 52, and an outer leg portion 54. The middle leg portion 52 and the outer leg portion 54 of the split core 50_1 protrude inward along the X-axis from an inner surface 581 of the base portion 58.

As shown in FIG. 5, the split core 50_1 is attached to the bobbin 1 so that the inner surface 581 of the base portion 58 faces an end surface 14a of the end flange portion 14 of the bobbin 1. The middle leg portion 52 of the split core 50_1 is inserted into the through hole 12 of the bobbin 1. The outer leg portion 54 of the split core 50_1 is disposed outward from the winding portion 30a in the Y-axis direction so that a space S1 is provided between an inner surface 541 of the outer leg portion 54 and the winding portion 30a. In the space S1 between the outer leg portion 54 and the winding portion 30a and the space S5 between the outermost layers 301 of the winding portion 30a in the sections, a sealing member 9 is disposed.

As shown in FIG. 3A, the split core 50_2 has a shape symmetric with that of the split core 50_1 with respect to an XZ plane. The split core 50_2 includes a base portion 58, a middle leg portion 52, and an outer leg portion 56.

As shown in FIG. 5, the split core 50_2 is attached to the bobbin 1 so that an inner surface 581 of the base portion 58 faces the end surface 14a of the end flange portion 14 of the bobbin 1. The middle leg portion 52 of the split core 50_2 is inserted into the through hole 12 of the bobbin 1. The outer leg portion 56 of the split core 50_2 is disposed outward from the winding portion 30a in the Y-axis direction so that the space S1 is provided between an inner surface 561 of the outer leg portion 56 and the winding portion 30a. In the space S1 between the outer leg portion 56 and the winding portion 30a and the space S5 between the outermost layers 301 of the winding portion 30a in the sections, the sealing member 9 is disposed. The split cores 50_1 and 50_2 are attached to the bobbin 1, with a space between split surfaces 60; however, how the split cores are attached to the bobbin is not limited to this. The split cores 50_1 and 50_2 may be in contact with each other at the split surfaces 60.

As shown in FIG. 3A, the split core 50_3 has a shape symmetric with that of the split core 50_1 with respect to a YZ plane. The split core 50_3 includes a base portion 58, a middle leg portion 52, and an outer leg portion 54.

As shown in FIG. 5, the split core 50_3 is attached to the bobbin 1 so that an inner surface 581 of the base portion 58 faces an end surface 16a of the end flange portion 16 of the bobbin 1. The middle leg portion 52 of the split core 50_3 is inserted into the through hole 12 of the bobbin 1. The outer leg portion 54 of the split core 50_3 is disposed outward from the winding portion 30b in the Y-axis direction so that the space S1 is provided between an inner surface 541 of the outer leg portion 54 and the winding portion 30b. In the space S1 between the outer leg portion 54 and the winding portion 30b and the space S5 between the outermost layers 301 of the winding portion 30b in the sections, the sealing member 9 is disposed.

As shown in FIG. 3A, the split core 50_4 has a shape symmetric with that of the split core 50_2 with respect to a YZ plane and symmetric with that of the split core 50_3 with respect to an XZ plane. The split core 50_4 includes a base portion 58, a middle leg portion 52, and an outer leg portion 56.

As shown in FIG. 5, the split core 50_4 is attached to the bobbin 1 so that an inner surface 581 of the base portion 58 faces the end surface 16a of the end flange portion 16 of the bobbin 1. The middle leg portion 52 of the split core 50_4 is inserted into the through hole 12 of the bobbin 1. The outer leg portion 56 of the split core 50_4 is disposed outward from the winding portion 30b in the Y-axis direction so that the space S1 is provided between an inner surface 561 of the outer leg portion 56 and the winding portion 30b. In the space S1 between the outer leg portion 56 and the winding portion 30b and the space S5 between the outermost layers 301 of the winding portion 30b in the sections, the sealing member 9 is disposed. The split cores 50_3 and 50_4 are attached to the bobbin 1, with a space between split surfaces 60; however, how the split cores are attached to the bobbin is not limited to this. The split cores 50_3 and 50_4 may be in contact with each other at the split surfaces 60.

As shown in FIG. 5, in the present embodiment, the split cores 50_3 and 50_4 are attached to the bobbin 1 so that split surfaces 62 of the split cores 50_3 and 50_4 are in contact with split surfaces 62 of the split cores 50_1 and 50_2; however, there may be a space therebetween.

As shown in FIG. 6A, the space S1 between the outer leg portions 54 of the core 5 and the winding portions 30 and the space S5 between the sections are provided along a circumferential direction of the winding portions 30. At a space S4 between the bottom surface 70 of the case 7 at the lower side in the Z-axis direction and the winding portions 30, the space S1 between the outer leg portions 54 of the core 5 and the winding portions 30 and the space S1 between the outer leg portions 56 and the winding portions 30 are connected. The description of the space S1 between the outer leg portions 54 of the core 5 and the winding portions 30 and the space S5 between the sections applies to the space S1 between the outer leg portions 56 and the winding portions 30 unless the spaces have different natures.

As shown in FIG. 5, the space S1 between the outer leg portions 54 of the core 5 and the winding portions 30 may have any width W1. The width W1 may be 1.0 mm to 2.0 mm. The width W2 of a space S2 between side surfaces 71 and 72 of the case 7 and outer surfaces 582 of the base portions 58 of the core 5 may be smaller than the width W1 of the space S1. The width W2 may be, for example, 0.3 mm to 0.6 mm. The width W3 of a space S3 between side surfaces 73 and 74 of the case 7 and outer surfaces 542 and 562 of the outer leg portions 54 and 56 of the core 5 may be smaller than the width W1 of the space S1. The width W3 may be, for example, 0.3 mm to 0.6 mm.

As shown in FIG. 5, the width W5 of the space S5 between the sections is not limited. The width W5 may be equivalent to or larger than the width W1 of the space S1 between the outer leg portions 54 and the winding portions 30. The width W5 may be, for example, 1.0 mm to 2.5 mm.

As shown in FIGS. 5, 6A, and 7, the bobbin 1, the wires 3, and the core 5 are accommodated in the case 7 and are sealed with the sealing member 9. In the present embodiment, upper portions of the bobbin 1, the wires 3, and the core 5 are partly exposed from the sealing member 9; however, they may be, except for the lead portions, entirely covered with the sealing member 9. As shown in FIG. 7, in the present embodiment, the end flange portions 14 and 16 of the bobbin 1 are partly exposed above from the case 7 in the Z-axis direction. This makes it easy to fill the case 7 with the sealing member 9.

As shown in FIGS. 5 and 6A, the sealing member 9 is disposed in the space S2 between the base portions 58 of the core and the side surfaces 71 and 72 of the case and in the space S3 between the outer leg portions 54 and 56 and the side surfaces 73 and 74. As shown in FIG. 6A, the sealing member 9 is also disposed in the space S1 between the outer leg portions 54 and 56 of the core 5 and the winding portions 30 and in the space S4 between the bottom surface 70 of the case 7 and the winding portions 30. As shown in FIGS. 5 and 6A, the sealing member 9 may be disposed also in the notches 22 of the partition flange portions 20.

In the present embodiment, the sealing member 9 includes a potting resin 91. The potting resin 91 of the sealing member 9 is not limited. As the potting resin 91, a known potting resin can be used. A potting resin with a coefficient of linear thermal expansion of 20×10⁻⁶ to 45×10⁻⁶/° C. may be suitably used.

The sealing member 9 may include a known heat-dissipating filler. With the heat-dissipating filler, the sealing member 9 has higher heat-dissipation capability, allowing more efficient dissipation of heat generated at the coil.

As shown in FIG. 6B, in the space S1 and the space S5, low-expansion particles 92 with a smaller coefficient of linear thermal expansion than that of the potting resin 91 are disposed. Spaces between the low-expansion particles 92 may be filled with the potting resin 91. Such an arrangement of the low-expansion particles 92 with a smaller coefficient of linear thermal expansion than that of the potting resin 91 in the space S1 and the space S5 makes at least the volume proportion of the potting resin 91 in the spaces between the peripheral edges 21 of the partition flange portions 20 and the outer leg portions 54 and 56 (the space S1 and the space S5) smaller than the volume proportion of the potting resin 91 in the space S3 between the outer leg portions 54 and 56 and the case 7. The volume proportion of the potting resin 91 in the space S1, the volume proportion of the potting resin 91 in the space S5, and the volume proportion of the potting resin 91 in the space S3 are not limited; however, the volume proportion of the potting resin 91 in the space S1 and the volume proportion of the potting resin 91 in the space S5 may be 80% or less or 50% or less of the volume proportion of the potting resin 91 in the space S3.

The low-expansion particles 92 are not limited. Those with a coefficient of linear thermal expansion of 7.5×10⁻⁶/° C. or less may be suitably used. Those with a coefficient of linear thermal expansion of 7.2×10⁻⁶/° C. or less may be more suitably used. The low-expansion particles 92 may have any shape. The low-expansion particles 92 may be substantially spherical or fibrous. However, the particles may be substantially spherical for good packing in the space S1 and the space S5. Also, the low-expansion particles 92 may be insulating in terms of ensuring insulation between the winding portions 30 and the outer leg portions 54 and 56 in the space S1.

The low-expansion particles 92 may contain a ceramic material. This ceramic material may contain, for example, at least one selected from the group consisting of an oxide, a nitride, and a carbide. Alternatively, the ceramic material may contain at least one selected from the group consisting of alumina, silicon nitride, aluminum nitride, and silicon carbide. Having excellent heat-dissipation capability, such materials may be suitably used as the low-expansion particles 92. In particular, substantially spherical alumina balls may be suitably used as the low-expansion particles 92.

The low-expansion particles 92 have a width smaller than the width W5 of the partition flange portions 20 and smaller than the width W1 of the space S1. The low-expansion particles 92 may include multiple types of particles with different particle sizes. Multiple types of particles with different particle sizes constituting the low-expansion particles 92 enable more low-expansion particles 92 to be disposed in the space S1 and the space S5. The low-expansion particles 92 may include, for example, first particles 92a with a particle size of 0.8 to 1.0 mm and second particles 92b with a particle size of 0.5 to 0.7 μm. The low-expansion particles 92 may further include third particles with a particle size different from that of the first particles or the second particles.

As described above, the low-expansion particles 92 are disposed at least in the space S1 and the space S5; however, as shown in FIG. 5, besides the space S1 and the space S5, the space S4 between the bottom surface 70 of the case 7 and the winding portions 30 (see FIG. 7) or spaces between the inner surfaces 541 and 561 of the outer leg portions 54 and 56 and the wound portion 11 of the bobbin 1 (e.g., spaces between the end flange portions 14 and 16 and the winding portions 30 or spaces between the wires 3) may be packed with the low-expansion particles 92.

The coil device 100 according to the present embodiment can be assembled, for example, as follows.

First, as shown in FIG. 4A, the wires 3 (3a and 3b) are wound around the bobbin 1. Then, to the bobbin 1, the core 5 (50_1, 50_2, 50_3, and 50_4) is attached. Then, they are accommodated in the case 7.

While the bobbin 1, the wires 3 (3a and 3b), and the core 5 (50_1, 50_2, 50_3, and 50_4) are accommodated in the case 7, the low-expansion particles 92 are poured into the space S5 and the space S1 from above in the Z-axis direction. In this manner, the spaces between the inner surfaces 541 and 561 of the outer leg portions 54 and 56 and the wound portion 11 of the bobbin 1 are packed with the low-expansion particles 92.

In the present embodiment, the low-expansion particles 92 have a width smaller than the width W5 of the partition flange portions 20 and smaller than the width W1 of the space S1; however, most of the low-expansion particles 92 may have a width larger than the width W2 of the space S2 between the base portions 58 of the core 5 and the side surfaces 71 and 72 of the case. This enables, as shown in FIG. 7, the low-expansion particles 92 to pack the space S4 between the winding portions 30 and the bottom surface 70 of the case 7 and a space between the mounting portions 153 and 173 of the bobbin 1 and the bottom surface 70 while being prevented from getting outward from the base portions 58 of the core 5 through the space S2. The low-expansion particles 92 may include those with a particle size smaller than the width W2 of the space S2 to the extent that effects of the present embodiment are not hindered.

Then, from above in the Z-axis direction, the sealing member 9 is poured into the case 7. This fills spaces in the case 7 (e.g., the spaces S2 and S3 between the core 5 and the case 7, the space S1, the spaces between the end flange portions 14 and 16 and the winding portions 30, and the space S5 between the wires 3) with the sealing member 9.

As described above, in the coil device 100 according to the present embodiment, at least a part of the winding portions 30 and at least a part of the outer leg portions 54 and 56 are accommodated in the case 7; and the at least a part of the winding portions 30 and the at least a part of the outer leg portions 54 and 56 in the case 7 are sealed with the sealing member 9. As shown in FIG. 5, the low-expansion particles 92 with a smaller coefficient of linear thermal expansion than that of the potting resin 91 of the sealing member 9 are not disposed in the space S2 between the base portions 58 of the core and the side surfaces 71 and 72 of the case or in the space S3 between the outer leg portions 54 and 56 and the side surfaces 73 and 74 but are disposed at least in the space S5 between the outermost layers 301 in the sections and the space S1 between the winding portions 30 and the outer leg portions 54 and 56. Thus, the volume proportion of the potting resin 91 inward from the inner surfaces 541 and 561 of the outer leg portions 54 and 56 (region including the space S5 and the space S1) is smaller than the volume proportion of the potting resin 91 outward from the outer surfaces 542 and 562 of the outer leg portions 54 and 56 (space S3).

The outer leg portions 54 and 56 of the core 5 are vulnerable to outward force; however, because the volume proportion of the potting resin 91 in the space S5 between the sections and the volume proportion of the potting resin 91 in the space S1 between the winding portions 30 and the outer leg portions 54 and 56 are small, the sealing member 9 in the space S5 and the space S1 is less prone to thermal expansion, and outward force on the outer leg portions 54 and 56 is less easily exerted. In particular, in the present embodiment, due to the presence of the space S5 between the sections provided by the partition flange portions 20, the sealing member 9 such as the one including the low-expansion particles 92 with a small coefficient of linear thermal expansion is easily and securely disposed inward from the outer leg portions 54 and 56. Thus, the sealing member 9 disposed inward from the outer leg portions 54 and 56 is less prone to expand than the sealing member 9 disposed outward from the outer leg portions 54 and 56. The coil device of the present disclosure can thereby have higher reliability against heat generation by a coil without being increased in size.

Because just the arrangement of the low-expansion particles 92 in the space S5 and the space S1 in advance and sealing with the inexpensive potting resin 91 can enhance reliability against heat generation without use of an expensive potting resin with a small coefficient of linear thermal expansion, the coil device 100 can be manufactured with lower manufacturing costs.

As described above, the sealing member 9 is disposed also at least in the space S3 between the outer leg portions 54 and 56 and the side surfaces 73 and 74 of the case 7. As inward force on the outer leg portions 54 and 56 of the core 5 is reduced, outward force on the outer leg portions 54 and 56 is relatively strongly exerted. Such an arrangement of the sealing member 9 also in the space S3 between the outer leg portions 54 and 56 and the side surfaces 73 and 74 of the case 7 enables outward force and inward force on the outer leg portions 54 and 56 to be balanced, enhancing durability.

In the present embodiment, as described above, the potting resin 91 is disposed also in the spaces between the low-expansion particles 92. Such an arrangement of the potting resin 91 enables the sealing member 9 to efficiently dissipate heat generated at the coil. Such an arrangement of the potting resin 91 does not affect reliability of the coil device 100 against heat generation, because the presence of the low-expansion particles 92 makes it difficult for force by expansion of the potting resin 91 to be transferred to the outer leg portions 54 and 56.

As shown in FIG. 6A, in the present embodiment, the low-expansion particles 92 are disposed in the space S5 between the sections and the space S1 between the winding portions 30 and the outer leg portions 54 and 56 along the circumferential direction of the winding portions 30. Such an arrangement enables outward force on the outer leg portions 54 and 56 to be more effectively reduced.

As shown in FIG. 6B, the low-expansion particles 92 have a substantially spherical shape. Such low-expansion particles 92 are easily disposed in the space S1 between the winding portions 30 and the outer leg portions 54 and 56, enabling the potting resin 91 in the space S1 between the winding portions 30 and the outer leg portions 54 and 56 to be efficiently reduced.

As shown in FIG. 6B, the low-expansion particles 92 include two or more types of the particles 92a and 92b with different particle sizes. In terms of reducing the volume proportion of the potting resin 91 inward from the inner surfaces 541 and 561 of the outer leg portions 54 and 56 (the region including the space S1), the low-expansion particles 92 can form a close-packed structure in this region.

As shown in FIG. 5, the peripheral edges 21 of the partition flange portions 20 are disposed farther from the wound portion 11 than the inner ends 301b of the outermost layers 301 are. Thus, the winding portions 30 can be evenly disposed in the sections between the partition flange portions 20 without being irregularly wound. Such an arrangement of the winding portions 30 enables the sealing member 9 to be securely disposed inward from the outer leg portions 54 and 56.

As shown in FIG. 5, the thickness W5 of the partition flange portions 20 is equivalent to or larger than the width W1 of the space S1 between the winding portions 30 and the outer leg portions 54 and 56. Thus, the sealing member 9 is easily disposed inward from the outer leg portions 54 and 56 even if the sealing member 9 includes the large-sized particles 92a.

As shown in FIGS. 4B and 4C, the partition flange portions 20 have the notches 22. As shown in FIG. 5, the wound portion 11 has the outer circumferential holes 13 at the locations corresponding to the notches 22. Through such outer circumferential holes 13, the sealing member 9 can easily enter the through hole 12 of the wound portion 11, more effectively increasing heat-dissipation capability of the coil device 100.

### Second Embodiment

The present embodiment has structures similar to those of the first embodiment except that a core 5a has a structure different from that of the core 5 of the first embodiment. The structures of the present embodiment different from those of the first embodiment are mainly described below.

In the present embodiment, as shown in FIG. 3B, the core 5a includes split cores 50_5, 50_6, 50_7, and 50_8 in combination. The split core 50_5 has a shape symmetric with that of the split core 50_6 with respect to an XY plane. The split cores 50_5 and 50_6 each include a base portion 58, a middle leg portion 52, and outer leg portions 54 and 56.

As shown in FIG. 3B, the split core 50_7 has a shape symmetric with that of the split core 50_5 with respect to a YZ plane. The split core 50_8 has a shape symmetric with that of the split core 50_6 with respect to a YZ plane and symmetric with that of the split core 50_7 with respect to an XY plane. The split cores 50_7 and 50_8 each include a base portion 58, a middle leg portion 52, and outer leg portions 54 and 56.

With such structures, the present embodiment produces effects similar to those of the first embodiment.

### Third Embodiment

The present embodiment has structures similar to those of the first embodiment except that a core 5b has a structure different from that of the core 5 of the first embodiment. The structures of the present embodiment different from those of the first embodiment are mainly described below.

In the present embodiment, as shown in FIG. 3C, the core 5b includes split cores 50_9, 50_10, and 50_11 in combination. The split core 50_9 has a shape symmetric with that of the split core 50_10 with respect to a YZ plane. The split cores 50_9 and 50_10 each include a base portion 58 and outer leg portions 54 and 56. The split core 50_11 has a substantially cylindrical shape.

They can be assembled, for example, as follows. First, the split core 50_11 is disposed inside a through hole 12 of a bobbin 1 shown in FIG. 4A. Then, the split core 50_9 is attached to an end flange portion 14 so that an inner surface 581 of the base portion 58 is in contact with an end surface 64a of the split core 50_11. Then, the split core 50_10 is attached to an end flange portion 16 so that an inner surface 581 of the base portion 58 is in contact with an end surface 64b of the split core 50_11.

With such structures, the present embodiment produces effects similar to those of the first embodiment.

In each of the above embodiments, an example of using the coil device mainly as a transformer has been demonstrated; however, the coil device may be used as a coil device other than a transformer.

The present disclosure is not limited to the above embodiments and can be variously modified to the extent that technical problems do not arise. Also, the structures of each embodiment may be appropriately recombined.

For example, the bobbin may be vertically disposed in the case 7 so that the wound portion 11 of the bobbin 1 stays along the Z-axis direction.

### REFERENCE NUMERALS

100 . . . coil device
1 . . . bobbin
11 . . . wound portion
12 . . . through hole
13 . . . outer circumferential hole
14 . . . end flange portion
14a . . . end surface
151, 152 . . . lead groove
153 . . . mounting portion
16 . . . end flange portion
16a . . . end surface
171, 172 . . . lead groove
173 . . . mounting portion
20 . . . partition flange portion
21 . . . peripheral edge
22 . . . notch
3 (3a, 3b) . . . wire
30 (30a, 30b) . . . winding portion
301 . . . outermost layer
301a . . . outer end
301b . . . inner end
31a, 32a, 31b, 32b . . . lead portion
5, 5a, 5b . . . core
50_1, 50_2, 50_3, 50_4 . . . split core
50_5, 50_6, 50_7, 50_8 . . . split core
50_9, 50_10, 50_11 . . . split core
52 . . . middle leg portion
54, 56 . . . outer leg portion
541, 561 . . . inner surface
542, 562 . . . outer surface
58 . . . base portion
581 . . . inner surface
582 . . . outer surface
60, 62 . . . split surface
64a, 64b . . . end surface
7 . . . case
70 . . . bottom surface
71, 72, 73, 74 . . . side surface
9 . . . sealing member
91 . . . potting resin
92 . . . low-expansion particle
92a . . . first particle
92b . . . second particle

What is claimed is:

1. A coil device comprising:
a wire;
a bobbin comprising a wound portion provided with a winding portion of the wire;
a core comprising an outer leg portion disposed outward from the winding portion; and
a case accommodating at least a part of the winding portion and at least a part of the outer leg portion,
wherein
the at least a part of the winding portion and the at least a part of the outer leg portion in the case are sealed with a sealing member,
the wound portion of the bobbin comprises a partition flange portion partitioning the winding portion into sections along a winding axis of the winding portion, and
the partition flange portion comprises a peripheral edge in a radial direction disposed closer to the wound portion than an outer end of an outermost layer of the winding portion is.

2. The coil device according to claim 1, wherein the peripheral edge of the partition flange portion is disposed farther from the wound portion than an inner end of the outermost layer of the winding portion is.

3. The coil device according to claim 1, wherein the partition flange portion has a thickness not smaller than a width of a space between the winding portion and the outer leg portion.

4. The coil device according to claim 1, wherein
the partition flange portion has notches, and
the wound portion has outer circumferential holes at locations corresponding to the notches.

5. The coil device according to claim 1, wherein low-expansion particles with a smaller coefficient of linear thermal expansion than that of a potting resin included in the sealing member are disposed in a space between the partition flange portion and the outer leg portion along a circumferential direction of the winding portion.

6. The coil device according to claim 5, wherein the potting resin occupies a smaller volume proportion in the space between the partition flange portion and the outer leg portion than in a space between the outer leg portion and the case.

7. The coil device according to claim 5, wherein the low-expansion particles have a substantially spherical shape.

8. The coil device according to claim 5, wherein the low-expansion particles comprise at least two types of particles with different particle sizes.

9. The coil device according to claim 5, wherein the low-expansion particles comprise a ceramic material.

10. The coil device according to claim 1, wherein the sealing member comprises a heat-dissipating filler.

11. The coil device according to claim 1, wherein the core comprises split cores.

12. The coil device according to claim 1, wherein the core comprises
a base portion disposed at one side of the winding portion in an axis direction of the winding portion, and
a middle leg portion that protrudes from the base portion and is disposed in a through hole of the bobbin.
